(19) United States
(12) Patent Application Publication
(10) Pub. No.: US 2024/0009673 A1
(43) Pub. Date: Jan. 11, 2024

(54) WORK MAT FOR SUPPORTING LABORATORY VESSELS

(71) Applicant: Mincle Co Pty Ltd, New South Wales (AU)

(72) Inventors: Jean PAYETTE, New South Wales (AU); Charles-Elliot Cedric SUNSTRUM, New South Wales (AU)

(73) Assignee: Mincle Co Pty Ltd, New South Wales (AU)

(21) Appl. No.: 18/253,487

(22) PCT Filed: Nov. 23, 2021
(86) PCT No.: PCT/AU2021/051392

§ 371 Date: May 18, 2023

(30) Foreign Application Priority Data
Nov. 23, 2020 (AU) 2020904324

(51) Int. Cl. B01L 9/02; B32B 3/30; B32B 27/40; B32B 5/18; B32B 27/08; B32B 5/32

(52) U.S. Cl. CPC B01L 9/02; B32B 3/30; B32B 27/40; B32B 5/18; B32B 27/08; B32B 5/32; B01L 2300/123; B01L 2300/0887; B32B 2274/00; B32B 2307/744; B32B 2266/0278; B32B 2266/06; B32B 2250/02; B32B 2405/00

(57) ABSTRACT

Work mat 10 for supporting laboratory vessels 12. The work mat 10 includes a flexible planar panel 14 having opposed sides 16, 18, where one side 16 defines a base 20, and the other side 18 defines a vessel support portion 22. Each of the base 20 and the vessel support portion 22 are configured to allow releasably adhering the panel 14 to another object. The base 20 is configured to adhere to another object more firmly than the vessel support portion 22. In use, the base 20 is adherable to a surface 24 (FIG. 7) and the vessel support portion 22 is adherable and removable from a laboratory vessel 12 without detaching the base 20 from the surface 24

### CROSS REFERENCE TO RELATED APPLICATIONS

This application claims priority to Australian provisional patent application no. 2020904324, filed on 23 Nov. 2021, the disclosure of which is incorporated herein by reference in its entirety.

### TECHNICAL FIELD

The present disclosure relates, generally, to work mats for supporting vessels and, in particular, to work mats for supporting laboratory vessels containing fluid.

### BACKGROUND

Many laboratory applications require fixedly supporting a vessel containing fluid, such as a beaker, Petri dish, flask, or the like, in a position throughout at least a portion of a procedure. Often, vessels need to be held in a fixed position on a platform or tray of laboratory apparatus, for example, to allow the contents of the vessel to be agitated by a shaker or mixer, or to be transported on the tray and stored within an incubator. This has typically involved using clamps or similar mechanical devices to releasably secure the vessel to the apparatus, or another substrate.

Any discussion of documents, acts, materials, devices, articles or the like which has been included in the present specification is not to be taken as an admission that any or all of these matters were common general knowledge in the field relevant to the present disclosure as it existed before the priority date of each of the appended claims.

### SUMMARY

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

According to one aspect of the disclosure, there is provided a work mat for supporting laboratory vessels. The work mat includes a flexible planar panel having opposed sides, one side defining a base, and the other side defining a vessel support portion. Each of the base and the vessel support portion are configured to allow releasably adhering the panel to another object. The base is configured to adhere to another object more firmly than the vessel support portion such that, in use, the base is adherable to a surface and the support portion is adherable and removable from a laboratory vessel without detaching the base from the surface.

The base may define a continuous planar surface, and the vessel support portion defines a discontinuous planar surface. It will be appreciated that the continuous planar surface may be substantially continuous, such as defining scores to allow flexing the panel. The discontinuous planar surface may be defined by a plurality of lands separated by grooves. The lands may form elongate strips which are arranged to be parallel to each other.

The discontinuous planar surface may define a surface area of less than or equal to 75% of the continuous planar surface. In some embodiments, the discontinuous planar surface may define a surface area of less than or equal to 50% of the continuous planar surface.

The panel may be formed from a resiliently deformable polymer. The panel may be formed from a polyurethane elastomer.

The panel may comprise a first layer formed from a first material and defining the base, and a second layer formed from a second material and defining the vessel support portion, and the first material be configured to be different to the second material to cause firmer adhesion to another object.

Each of the base and the vessel support portion may be configured to be tacky.

The work mat as described in any of the above paragraphs may be configured as a module and form part of a work mat system comprising a plurality of the modules, such that the modules are securable adjacent to each other on a surface to cover at least a portion of the surface. Each of the modules may be identical.

It will be appreciated embodiments may comprise steps, features and/or integers disclosed herein or indicated in the specification of this application individually or collectively, and any and all combinations of two or more of said steps or features.

### BRIEF DESCRIPTION OF DRAWINGS

Embodiments will now be described by way of example only with reference to the accompany drawings in which:

FIG. 1 is a top perspective view of a first embodiment of a work mat for supporting laboratory vessels;

FIG. 2 is a bottom perspective view of the embodiment shown in FIG. 1;

FIGS. 3 and 4 are a side view, and side-detail view, respectively, of the embodiment shown in the previous figures;

FIG. 5 is a top perspective view of a second embodiment of a work mat for supporting laboratory vessels;

FIG. 6 is a plan view of a system comprising a plurality of the work mats shown in FIG. 5; and

FIG. 7 is a side view of a vessel being carried by the embodiment shown in FIGS. 1 to 4.

### DESCRIPTION OF EMBODIMENTS

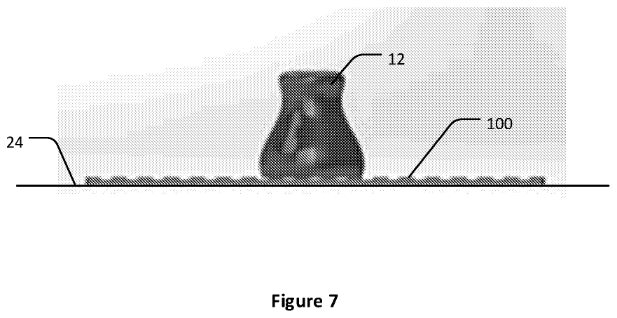

In the drawings, reference numeral 10 generally designates a work mat 10 for supporting laboratory vessels 12 (FIG. 7). The work mat 10 includes a flexible planar panel 14 having opposed sides 16, 18, where one side 16 defines a base 20, and the other side 18 defines a vessel support portion 22. Each of the base 20 and the vessel support portion 22 are configured to allow releasably adhering the panel 14 to another object. The base 20 is configured to adhere to another object more firmly than the vessel support portion 22. In use, the base 20 is adherable to a surface 24 (FIG. 7) and the vessel support portion 22 is adherable and removable from a laboratory vessel 12 without detaching the base 20 from the surface 24.

The mat 10 is described with reference to supporting laboratory vessels, such as flasks, bottles, dishes, or the like, during a laboratory procedure, such as during experiments. It will be appreciated that the mat 10 is usable in other applications, such as medical environments, for example, to support vessels in a surgical theatre, or in manufacturing environments, such as in the commercial production of a biologic drug, such as supporting a vessel containing cells along a seed train. One typical application is the mat 10 being arranged to support flasks which are agitated, typically by shaking, while containing single cell suspension cultures in an environmentally controlled incubator.

The mat 10 may be formed from a material having inherent adhesive, tacky, or tacky/adhesive-like, properties. The mat 10 may be formed from a resiliently deformable polymer. Typically, the mat 10, or at least the base 20 and the vessel support portion 22, is formed from an elastomer, such as a polyurethane elastomer, to enhance friction between the mat 10 and another object to inhibit relative movement and consequently enhance adhering the mat 10 to the object. When formed from an elastomer, the material may be configurable to define sticky or tacky surfaces. For example, where the mat 10 is formed from a polyurethane elastomer, this may be formed from a polyurethane prepolymer A/B including methylenediphenyl diisocyanate, polyethylene glycol, bis terephthalate, and bismuth citrate.

The mat 10 is typically formed from a material configured to be chemically inert, such as to inhibit or prevent leeching of chemicals, which could contaminate the contents of a vessel supported on the mat 10 to affect cell growth in the vessel. Polyurethane elastomer has been found to be suitable for this purpose.

In some embodiments, the mat 10 is formed from an open-cell foam, for example, a polyurethane foam. When formed from an open-cell foam, the open-cell structure defines pores (not illustrated) in surfaces of the mat 100, 200. When the mat 100, 200 is pressed onto another object, such as a benchtop surface, the surface of the mat 100, 200 in contact with the object is deformed which urges air out of at least some of the pores. When force on the mat 100, 200 is released, the mat 100, 200 resiliently returns to its original shape. The negative pressure in the compressed pores causes a suction effect to adhere the contact surface of the mat 100, 200 to the object.

In other embodiments, the mat 10 is formed from a material carrying, or comprising, an adhesive, such as a polymer body carrying an adhesive layer. The adhesive may be sprayed onto the body after forming, such as by casting or injection moulding, or introduced to a mould prior to casting or moulding the body, such as by spraying liquid adhesive into the mould, or applying an adhesive film across at least a portion of the mould. In such embodiments, the adhesive is configured to only partially cure when exposed to ambient conditions such that the mat 10 has tacky surfaces which are releasably adherable to another object.

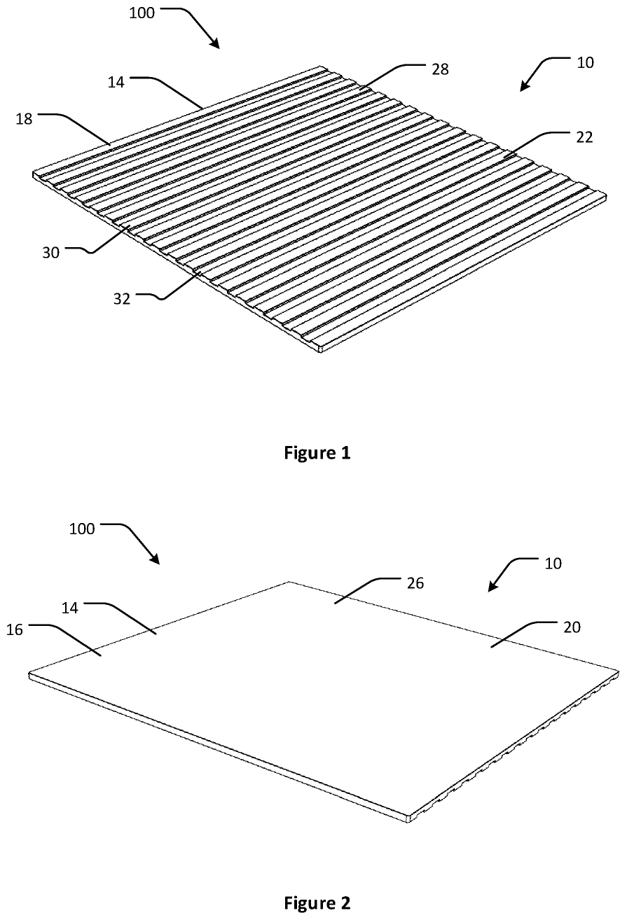

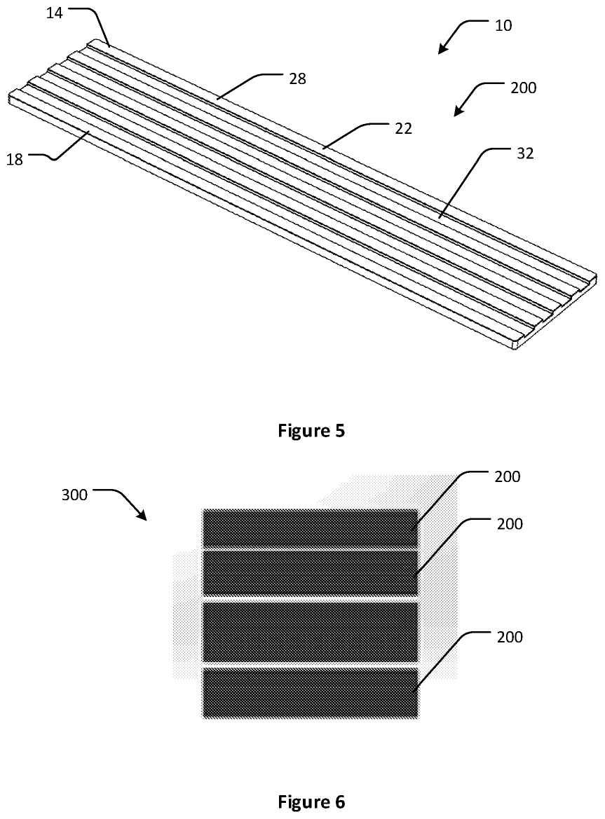

FIGS. 1 to 4 illustrate a first embodiment of the work mat 10 configured as a square-shaped mat 100. FIGS. 5 and 6 illustrate a second embodiment of the work mat 10 configured as strip-shaped mat 200. It will be appreciated that these embodiments 100, 200 are exemplary of the range of different shapes the mat 10 may be configured to define, and that the mat 10 is configurable to define many other profiles, such as circular, elliptical, triangular, or other polygons. In some embodiments (not illustrated), the mat 10 forms a sheet, which may be wrapped around a drum, and is configured to be cut to a desired shape, such as by being manually trimmed with scissors, to allow fitting to a specific surface in a laboratory, such as defined by a tray of an orbital shaker.

FIG. 1 illustrates the square-shaped mat 100 from above and FIG. 2 illustrates the mat 100 from below. Shown in FIG. 2, the base 20 of the mat 100 defines a substantially continuous planar surface 26. In the illustrated embodiment 100, this surface 26 is continuous however it will be appreciated that, in other embodiments (not illustrated), the surface 26 may define score lines, grooves, or other impressions, such as to enhance flexing of the mat 100.

Shown in FIG. 1, the vessel support portion 22 of the mat 100 defines a discontinuous planar surface 28 comprising a plurality of separate sub-surfaces. The discontinuous surface 28 is defined by a plurality of planar lands 30. In the illustrated embodiment 100, the vessel support portion 22 is shaped such that the lands 30 define elongate strips separated by grooves or channels 32. It will be appreciated that this arrangement is exemplary, and that the vessel support portion 22 may be shaped in other ways to define discontinuous surfaces. For example, in some embodiments (not illustrated), the vessel support portion 22 defines a grid of grooves such that the lands form square or rectangular sub-surfaces. In other embodiments (not illustrated), the vessel support portion 22 defines a plurality of parallel extending projections such that the lands 30 are formed on a top portion of each projection. In yet other embodiments, the vessel support portion 22 includes one or more arrays of domes arranged to support and grip a vessel.

Each land 30 is configured to have at least a portion which is planar to enhance contact area available to be placed against a vessel. This arrangement enhances being laid across, and consequently gripping, flat-bottomed vessels, such as flasks.

The configuration of the base 20 and the vessel support portion 22 of the mat 100 provides a larger contact surface area on the base 20 than is defined by the vessel support portion 22. This means that when the base 20 is placed on to a substrate, such as a platform of laboratory apparatus, the planar surface 26 adheres to the substrate. Typically, this is caused by friction between the planar surface 26 and the substrate however, as described above, this may alternatively or additionally be caused by suction exerted by the planar surface 26. When an object, such as a flat-bottomed vessel, is placed on the vessel support portion 22, the lands 30 in contact with the object adhere to the object, also typically caused by friction between the vessel support portion 22 and the object. Because of the discontinuous arrangement of the lands 30, the vessel support portion 22 adheres less firmly to the object than the base 20 adheres to the substrate. This allows a user to readily adhere vessels to, and remove vessels from, the vessel support portion 22 without causing the base 20 to detach from the substrate. Where the mat 100 is used to support a plurality of vessels, which for some applications can involve supporting around 50 vessels, this can usefully reduce the likelihood of the removal of one vessel from the mat 100 causing the mat 100 to bend and/or displace relative to the substrate and, as a result, shake or topple adjacently arranged vessels, which could negatively affect the contents of the shaken/toppled vessels.

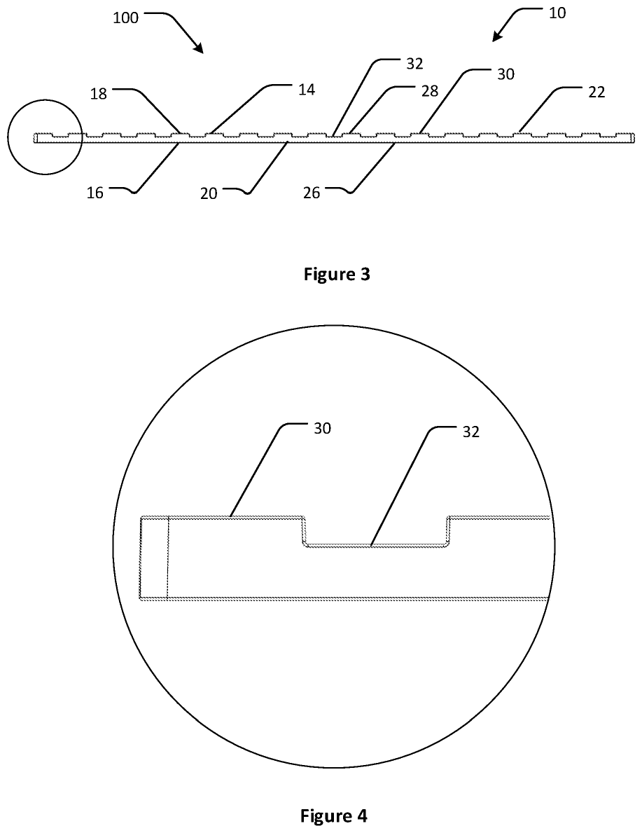

FIGS. 3 and 4 are side views of the mat 100 illustrating the lands 30 separated by the grooves 32. Best shown in the detailed view of FIG. 4, the lands 30 are dimensioned to define substantially the same width as the grooves 32. This arrangement provides a discontinuous planar surface 28 area of about 50% of the surface area of the continuous planar surface 26. It will be appreciated that the dimensional relationship of the lands 30 and grooves 32, or other impressions separating the lands 30, is variable to affect the ratio of discontinuous planar surface 28 area to continuous planar surface 26 area, which will affect the strength of adhesion of the vessel mount portion 22 compared to the base 20. For example, in some embodiments (not illustrated), the grooves 32 are dimensioned to be more narrow such that the discontinuous planar surface 28 area is about 75% of the surface area of the continuous planar surface 26, which results in the vessel mount portion 22 adhering more firmly to other objects, and being more comparable to the adhesion of the base 20 to another object. In yet other embodiments, the discontinuous planar surface 28 defines a surface area of less than or equal to 75% of the continuous planar surface 26, and in yet other embodiments, the discontinuous planar surface 28 defines a surface area of less than or equal to 50% of the continuous planar surface 26.

It will be appreciated that the ratio of discontinuous planar surface 28 area to continuous planar surface 26 may be varied according to use requirements, such as the size and/or weight of vessels to be supported by the mat 10, and/or the apparatus which the mat 10 will be mounted to. For example, where the mat 10 is intended to be mounted to an orbital shaker which runs at up to 250 revolutions per minute, the ratio may be configured to be closer to 75% to enhance adhesion between the vessel support portion 22 and vessels.

Also shown in FIGS. 3 and 4, the mat 100 is configured to define a thickness and the grooves dimensioned to extend halfway through the thickness. For example, the mat 100 may be around 6 mm thick and the grooves dimensioned to be around 3 mm deep.

FIG. 5 illustrates the strip-shaped mat 200. The mat 200 shares many features with the previously described mat 100, whereby common reference numerals indicate shared features.

The mat 200 is configured as a module to allow arranging adjacent other modules to form a work mat system 300, such as is illustrated in FIG. 6. The system 300 comprises a plurality of identical and/or non-identical modules to allow arranging the modules adjacent to each other on s substrate to cover a substantial surface area.

FIG. 7 illustrates the base 20 of the mat 100 adhered to a substrate, being a surface 24 in a laboratory, such as a benchtop or section of apparatus. A vessel 12 is adhered to the vessel support portion 22 of the mat 100.

The mats 100, 200 are typically formed by casting polymeric material, such as polyurethane, in a mould. In some embodiments, the mats 100, 200 are formed by injection moulding material.

In some embodiments (not illustrated), the mat 10 includes a panel comprising a first layer formed from a first material and defining the base, and a second layer formed from a second material and defining the vessel support portion, where the first material is configured to be different to the second material to cause firmer adhesion to another object. For example, in some embodiments, each of the first material and the second material include an adhesive component in the material, or carry an adhesive coating or layer, and the first material includes more of the adhesive component, or is carries adhesive specified to provide stronger adhesion, than the second material. In other embodiments, the composition of the first material is configured to be more tacky than the composition of the second material. It will be appreciated that, in such embodiments, each of the base and the vessel support portion may define a continuous surface for contacting and adhering to other objects.

Use of the mat 10 initially involves installing the mat 10 in a required location by placing the base 20 against a substrate, such as the surface 24, and pressing the base against the substrate to cause the base 20 to adhere to the substrate. One or more vessels 12 are then releasably fixed to the vessel support portion 22 by pressing a base of each vessel 12 to the support portion 22 to cause the support portion 22 to adhere to the vessel 12. Adhesion is optimised when a flat-bottomed vessel 12 is mounted to the mat 10 in this way. The vessel 12 is removable from the vessel support portion 22 by lifting and/or twisting the vessel 12. Because of the degree of adhesion between the support portion 22 and the vessel 12 is less than the degree of adhesion between the base 20 and the substrate, the vessel 12 is released from the mat 10 without causing the base 20 to detach from the substrate.

The configuration of the base 20 and vessel support portion 22 of the mat 10 inhibits removal of the mat 10 from a substrate during typical use, where vessels are often adhered to, and removed from, the vessel support portion 22. This can enhance efficiency of laboratory and/or commercial manufacturing operations by avoiding instances of re-mounting the mat 10 to the substrate. This can also reduce instances of undesired motion of the vessel, or other vessels supported on the mat 10, such as caused by sudden detachment of at least a portion of the mat 10 from the substrate, which could affect the contents of the vessel, for example, causing damage to living cells contained in the vessel.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A work mat for supporting laboratory vessels, the work mat including
a flexible planar panel having opposed sides, one side defining a base, and the other side defining a vessel support portion,
each of the base and the vessel support portion are configured to allow releasably adhering the panel to another object, wherein the base is configured to adhere to another object more firmly than the vessel support portion such that, in use, the base is adherable to a surface and the support portion is adherable and removable from a laboratory vessel without detaching the base from the surface.

2. The work mat of claim 1, wherein the base defines a continuous planar surface, and the vessel support portion defines a discontinuous planar surface.

3. The work mat of claim 2, wherein the discontinuous planar surface is defined by a plurality of lands separated by grooves.

4. The work mat of claim 3, wherein the lands form elongate strips, the strips arranged to be parallel to each other.

5. The work mat of claim 2, wherein the discontinuous planar surface defines a surface area of less than or equal to 75% of the continuous planar surface.

6. The work mat of claim 5, wherein the discontinuous planar surface defines a surface area of less than or equal to 50% of the continuous planar surface.

7. The work mat of claim 1, wherein the panel is formed from a resiliently deformable polymer.

8. The work mat of claim 7, wherein the panel is formed from a polyurethane elastomer.

9. The work mat of claim 1, wherein the panel comprises a first layer formed from a first material and defining the base, and a second layer formed from a second material and defining the vessel support portion, the first material being different to the second material to cause firmer adhesion to another object.

10. The work mat of claim 1, wherein each of the base and the vessel support portion are configured to be tacky.

11. A work mat system including a plurality of work mat modules according to claim 1, where the modules are securable adjacent to each other on a surface to cover at least a portion of the surface.

12. The work mat system of claim 11, wherein each of the modules are identical.
